(19) United States
(12) Patent Application Publication
(10) Pub. No.: US 2015/0090888 A1
(43) Pub. Date: Apr. 2, 2015

(54) Analyzer Device for Compensating a Scintillator and Method of Using the Same

(71) Applicant: Saint-Gobain Ceramics & Plastics, Inc., Worcester, MA (US)

(72) Inventor: Kan Yang, Solon, OH (US)

(21) Appl. No.: 14/492,490

(22) Filed: Sep. 22, 2014

Related U.S. Application Data
(60) Provisional application No. 61/883,703, filed on Sep. 27, 2013.

(51) Int. Cl. G01T 1/208; G01T 1/20

(52) U.S. Cl. CPC G01T 1/208; G01T 1/2006; G01T 1/2002
USPC 250/362; 250/369

(57) ABSTRACT

A radiation detection system can include a scintillator capable of emitting scintillating light in response to capturing radiation, a photosensor optically coupled to the scintillator, and an analyzer device electrically coupled to the photosensor. The analyzer device can include a plurality of circuits and can be configured to receive a pulse from the photosensor, analyze a pulse shape of the pulse, and adjust a pulse parameter based on the pulse shape, wherein the plurality of circuits is configured to perform the analysis of the pulse or the adjustment of the pulse. In an embodiment, the analyzer device can determine a rise time of the pulse, an integration of intensity over time, a pulse height of the pulse, a depth-of-interaction, or any combination thereof. In a further embodiment, the analyzer device can generate a compensation coefficient based on the rise time of the pulse to adjust the pulse height.

### CROSS-REFERENCE TO RELATED APPLICATION

This Application claims priority under 35 U.S.C. §119(e) to U.S. Provisional Application No. 61/883,703 entitled “Analyzer Device for Compensating A Scintillator and Method of Using the Same,” by Kan Yang, filed on Sep. 27, 2013. The above-referenced application is assigned to the current assignee hereof and is incorporated herein by reference in its entirety.

### FIELD OF THE DISCLOSURE

The present disclosure is directed to analyzer devices and methods of using such analyzer devices.

### BACKGROUND

Scintillator-based detectors are used in a variety of applications, including research in nuclear physics, oil exploration, field spectroscopy, container and baggage scanning, and medical diagnostics. When a scintillator material of the scintillator-based detector is exposed to ionizing radiation, the scintillator material absorbs energy of incoming radiation and scintillates, remitting the absorbed energy in the form of photons. A photosensor of the scintillator-based detector detects the emitted photons. Radiation detection systems can analyze pulses for many different reasons. Continued improvements in analysis techniques are desired.

### BRIEF DESCRIPTION OF THE DRAWINGS

Embodiments are illustrated by way of example and are not limited in the accompanying figures.

FIG. 1 includes a depiction of an analyzer device within a radiation detection system in accordance with an embodiment described herein.

FIG. 2 includes a block diagram illustrating a particular embodiment of an analyzer device.

FIG. 3 includes a flow chart of a process of using the analyzer device of FIG. 1 in accordance with an embodiment described herein.

FIGS. 4 and 5 include depictions of photon paths of photons emitted at different depths of interaction within a scintillator.

FIG. 6 includes a graph illustrating simulated pulse data for scintillation events occurring at different depths of interaction within a scintillator and a simulated intrinsic pulse shape of the scintillator.

FIG. 7 includes graphs illustrating simulated rise time pulse data for scintillation events at different depths of interaction within a scintillator and the simulated rise time of the intrinsic pulse shape of the scintillator.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes, ” “including, ” “has, ” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

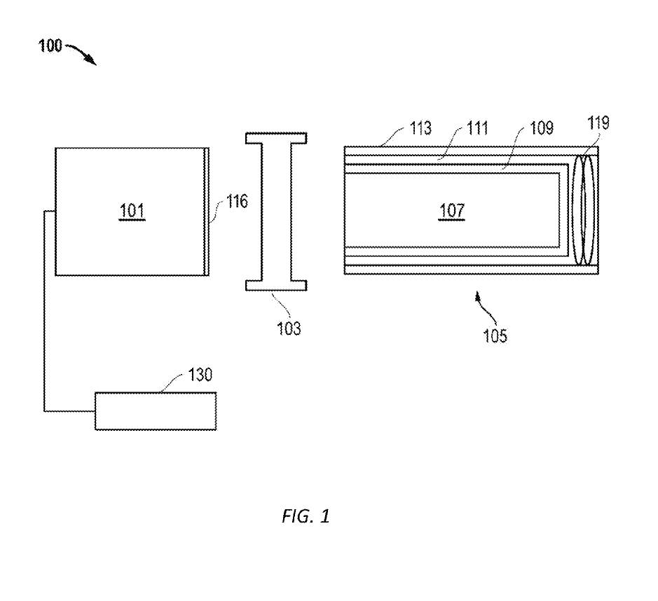

FIG. 1 illustrates an embodiment of a radiation detector system 100. The radiation detector system can be a medical imaging apparatus, a well logging apparatus, a security inspection apparatus, nuclear physics applications, or the like. In a particular embodiment, the radiation detection system can be used for gamma ray analysis, such as a Single Photon Emission Computed Tomography (SPECT) or Positron Emission Tomography (PET) analysis.

In the embodiment illustrated, the radiation detection system 100 includes a photosensor 101, an optical interface 103, and a scintillation device 105. Although the photosensor 101, the optical interface 103, and the scintillation device 105 are illustrated separate from each other, skilled artisans will appreciate that photosensor 101 and the scintillation device 105 can be coupled to the optical interface 103, with the optical interface 103 disposed between the photosensor 101 and the scintillation device 105. The scintillation device 105 and the photosensor 101 can be optically coupled to the optical interface 103 with other known coupling methods, such as the use of an optical gel or bonding agent, or directly through molecular adhesion of optically coupled elements.

The photosensor 101 can be a photomultiplier tube (PMT), a silicon photomultiplier (SiPM), a hybrid photosensor, or any combination thereof. The photosensor 101 can receive photons emitted by the scintillation device 105, via an input window 116, and produce electronic pulses based on numbers of photons that it receives.

The photosensor 101 is electrically coupled to an input of an analyzer device 130. The photosensor 101 can be housed within a tube or housing made of a material capable of protecting the photosensor 101, the analyzer device 130, or a combination thereof, such as a metal, metal alloy, other material, or any combination thereof. Although not illustrated in FIG. 1, an amplifier may be used to amplify the electronic signal from the photosensor 101 before it reaches the analyzer device 130. The electronic pulses can be shaped, digitized, analyzed, or any combination thereof by the analyzer device 130 to provide a count of the photons received at the photosensor 101 or other information. The analyzer device 130 can include an amplifier, a pre-amplifier, an analog-to-digital converter, a photon counter, another electronic component, or any combination thereof. The analyzer device 130 will be described in more detail later in this specification.

The scintillation device 105 includes a scintillator 107. The composition of the scintillator 107 will be described in more detail later in this specification. The scintillator 107 is substantially surrounded by a reflector 109. In one embodiment, the reflector 109 can include polytetrafluoroethylene (PTFE), another material adapted to reflect light emitted by the scintillator 107, or a combination thereof. In an illustrative embodiment, the reflector 109 can be substantially surrounded by a shock absorbing member 111. The scintillator 107, the reflector 109, and the shock absorbing member 111 can be housed within a casing 113.

The scintillation device 105 includes at least one stabilization mechanism adapted to reduce relative movement between the scintillator 107 and other elements of the scintillation device 105, such as the casing 113, the shock absorbing member 111, the reflector 109, or any combination thereof. The stabilization mechanism may include a spring 119, an elastomer, another suitable stabilization mechanism, or a combination thereof. The stabilization mechanism can be adapted to apply lateral forces, horizontal forces, or a combination thereof, to the scintillator 107 to stabilize its position relative to one or more other elements of the radiation detection system 100.

The scintillator 107 includes a material that can emit scintillation light in response to capturing targeted radiation. In an embodiment, the scintillator 107 can include a material that can produce a pulse having a rise time of no greater than 2 nanoseconds. In a particular embodiment, the scintillator 107 can include a material that can produce a pulse having a rise time of no greater than 1 nanosecond. In an alternate embodiment, the scintillator 107 can include a material that can produce a pulse having a decay time of no greater than 20 nanoseconds. In yet another embodiment, the scintillator 107 can include a material that can produce a pulse having a decay time of no greater than 15 nanoseconds.

In an embodiment, scintillator 107 can include a rare earth halide. A particularly well-suited material can have the chemical formula of La₍₁₋ₓ₎CeₓBr_{(3-3y)}Cl_{(3y)}, wherein x is any number in the range of 0 to 1 and y is any number in the range of 0 to 1. In a particular embodiment, x can be any number in the range of 1×10⁻³ to 0.4. In an alternative embodiment, the scintillator 10 can include La₍₁₋ₓ₎CeₓBr₃, wherein x is any number in the range of 1×10⁻³ to 0.4, Lu₂₍₁₋ₐY₂ₐSiO5, wherein a is any number in a range of 0 to 1, PbWO₄, BaF₂, CeF₃, or another suitable fast responding scintillator. Such scintillators may or may not include an activator.

In another embodiment, the scintillator 107 can include an organic scintillation material. In a particular embodiment, the organic scintillation material can include an aromatic compound. In a particular embodiment, the aromatic compound can be a homoaromatic compound or a heteroaromatic compound. In a more particular embodiment, the aromatic compound includes a phenyl or pyrazoline aromatic compound. In another particular embodiment, the organic scintillation material can include 2,5-diphenyloxazole (“PPO”), 9,10-diphenylanthracene (“DPA”), p-terphenyl, 1,4-bis[2-methylstyryl benzene] (“bis-MSB”), 1,4-bis(5-phenyloxazol-2-yl) benzene, naphthalene, and 1,1,4,4-tetraphenyl-1,3 butadiene (“TPB”), another suitable organic compound, or any combination thereof. The organic scintillation material can be mixed into a solvent, such as toluene, 1-phenyl-1-xylyl ethane (“PXE”), linear alkyl benzene (“LAB”), or another solvent. In an embodiment, the combination of the organic scintillation material and the solvent can be mixed into and dissolve within the polymer matrix.

As illustrated, the optical interface 103 is adapted to be coupled between the photosensor 101 and the scintillation device 105. The optical interface 103 is also adapted to facilitate optical coupling between the photosensor 101 and the scintillation device 105. The optical interface 103 can include a polymer, such as a silicone rubber, that is used to mitigate the refractive indices difference between the scintillator 107 and the input window 116 of the photosensor 101. In other embodiments, the optical interface 103 can include gels or colloids that include polymers and additional elements.

The scintillator 107 has a depth as measured from one end of the scintillator 107 to an opposing end. In an embodiment, the depth is at least 7.5 centimeters. In another embodiment, the scintillator 107 can have a depth of at least 12.5 centimeters. A location where radiation is captured during a scintillating event can be measured from the end of the scintillator 107 that is closer to the photosensor 101, and such measured distance is herein referred to as the depth of interaction (DOI).

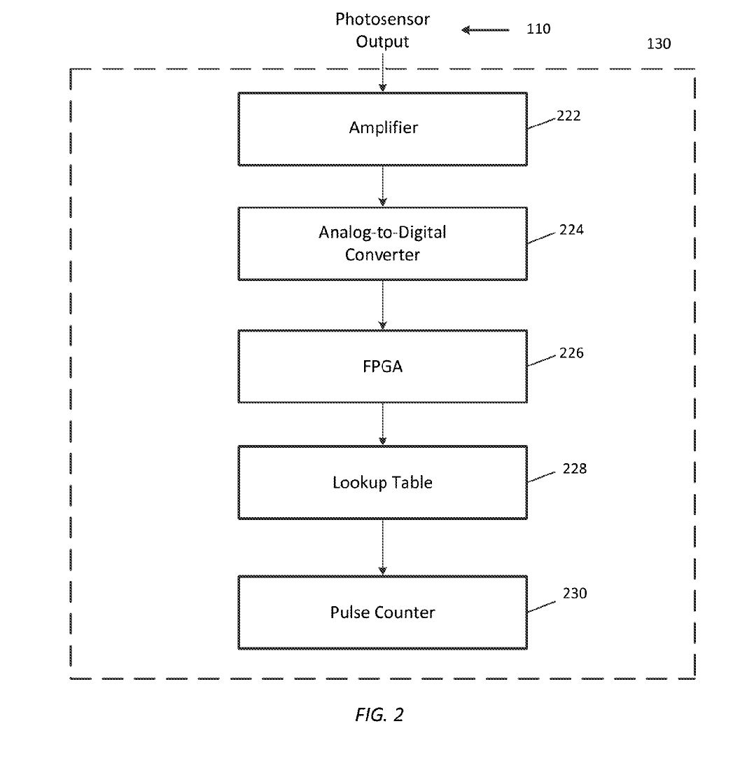

The analyzer device 130 can include hardware and can be at least partly implemented in software, firmware, or a combination thereof. In an embodiment, the hardware can include a plurality of circuits within a field programmable gate array (FPGA), an application specific integrated circuit (ASIC), another integrated circuit or on a printed circuit board, or another suitable device, or any combination thereof. The analyzer device 130 can also include a buffer to temporarily store data before the data are analyzed, written to storage, read, transmitted to another component or device, another suitable action is performed on the data, or any combination thereof. In the embodiment illustrated in FIG. 2, the analyzer device 130 can include an amplifier 222 coupled to a photosensor output 110, such that an electronic pulse from the photosensor 101 can be amplified before analysis. The amplifier 222 can be coupled to an analog-to-digital converter (ADC) 224 that can digitize the electronic pulse. The ADC 224 can be coupled to a field programmable gate array (FPGA) 226 that can include circuits to analyze the shape of the electronic pulse and determine a compensation coefficient using a look-up table 226. The look-up table 228 can be part of the FPGA 226 or may be in another device, such as an integrated circuit, a disk drive, or a suitable persistent memory device. The ADC 224, the FPGA 226, or another device performing digitization, pulse analysis, compensation coefficient generation, adjustment of a pulse parameter, or any combination thereof can have an operational frequency of 1 GHz.

A multichannel analyzer (MCA) 230 can be coupled to the device that includes the look-up table 228 or to the FPGA 226. The MCA 230 can generate pulse height spectrum based on the scintillation pulses, wherein the pulses may at least in part be based on compensated electronic pulses. Another device may be used in conjunction with or in place of the MCA 230. In an embodiment, the other device can include a discriminator to analyze the adjusted electronic pulse to identify a particular type of radiation, such as gamma, x-ray, neutrons, or beta, and send a signal to the appropriate counter, such as a pulse counter. In another embodiment, the compensated electronic pulse is analyzed to determine a particular radiation source, such as ⁶⁰Co, ¹³⁷Cs, or another suitable radiation source that corresponds to the scintillation event. The MCA 230 may not be used for this embodiment. For example, the adjusted pulse may be used to image a radiation source that emitted radiation that was captured by the scintillator 107. Other devices may be used in other embodiments, depending on the particular application.

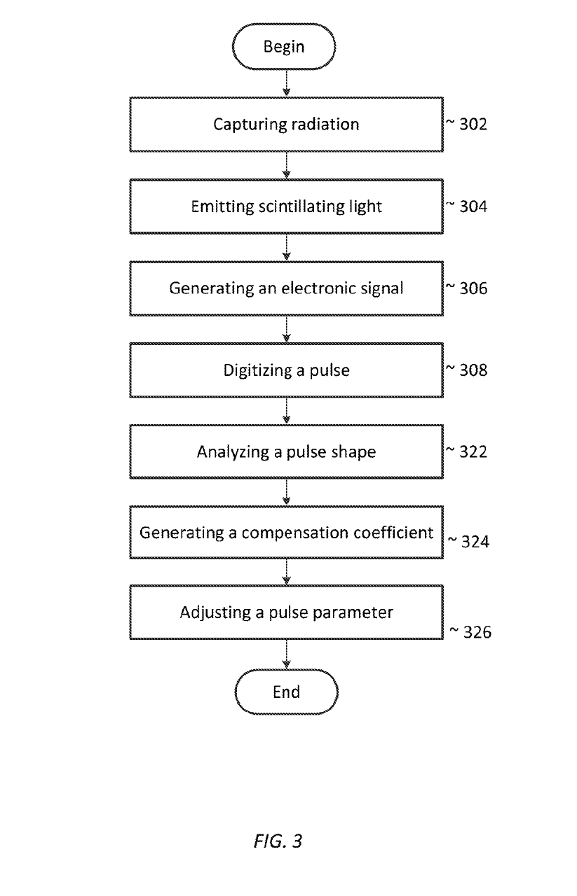

The analyzer device 130 can be configured to perform a variety of tasks. Some of the tasks listed herein are intended to be exemplary and not limiting. The analyzer device 130 can be configured to perform any one or more of the actions as described with respect to FIG. 3.

FIG. 3 includes a flowchart of an exemplary method of using the radiation detection system 100 including the analyzer device 130. The method will be described with respect to components within the radiation detection system 100 as illustrated in FIG. 1 and the analyzer device 130 as illustrated in FIG. 2. After reading this specification, skilled artisans will appreciate that activities described with respect to particular components may be performed by another component. Further, activities described with respect to particular components may be combined into a single component, and activities described with respect to a single component may be distributed between different components.

The method can begin with capturing radiation and emitting scintillating light, at blocks 302 and 304 in FIG. 3. The radiation can be captured by the scintillator 107, and the scintillating light can be emitted by the scintillator 107 in response to capturing the radiation. Such radiation capture and scintillating light emission corresponds to a scintillation event. The radiation capture occurs at a depth of interaction (DOI) that may be determined as described in more detail below. The method can further include generating an electronic pulse, at block 306. The photosensor 101 can generate the electronic pulse in response to receiving the scintillating light. The electronic pulse can be provided the electron pulse to an input of the analyzer device 130. In an embodiment, the electronic signal may be amplified by a pre-amplifier or an amplifier within the photosensor 101 or the analyzer device 130. The amplified electronic pulse can be digitized by the analog-to-digital converter 224, at block 308 of FIG. 3.

The method can also include analyzing the pulse shape of the digitized pulse, at block 322 in FIG. 3. In an embodiment, analyzing the pulse can be performed by the FPGA 224, an ASIC, or another suitable device. Analysis of the pulse can include determining a rise time of the pulse, an integration of intensity over time, a pulse height of the pulse, or any combination thereof.

Some of the concepts of pulse analysis will be better understood after considering how the location of a scintillation event within the scintillator 107 can affect the pulse produced by the photosensor 101. Numbers are used to improve understanding of the concepts described herein, and not to limit the scope of the present invention.

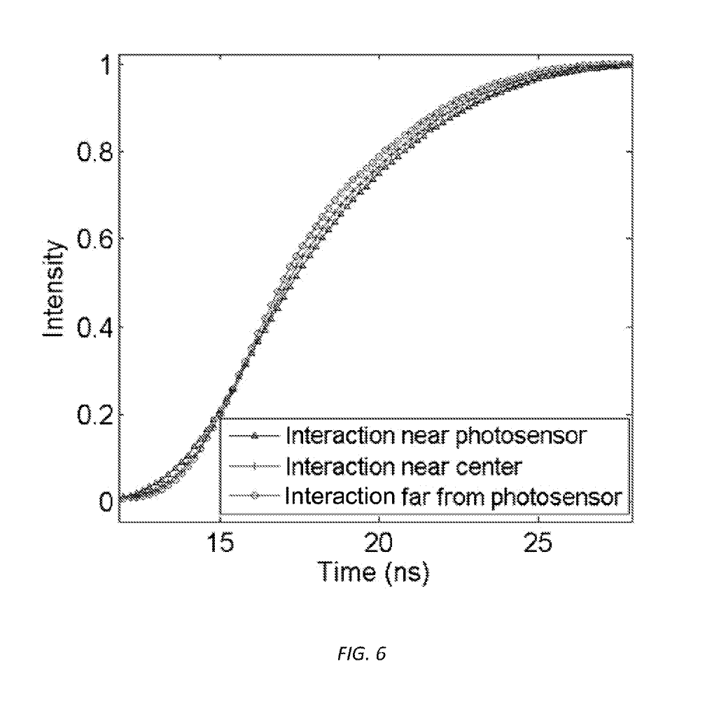

As will be explained in more detail below, a faster rise time corresponds to a larger DOI and a slower rise time corresponds to a smaller DOI. Such a finding is contrary to what is disclosed in WO2013/101956 (Stanford). Stanford describes and illustrates in FIGS. 5A, 5B, 6A, and 6B that a slower rise time correlates with a larger DOI and a faster rise time correlates with a smaller DOI.

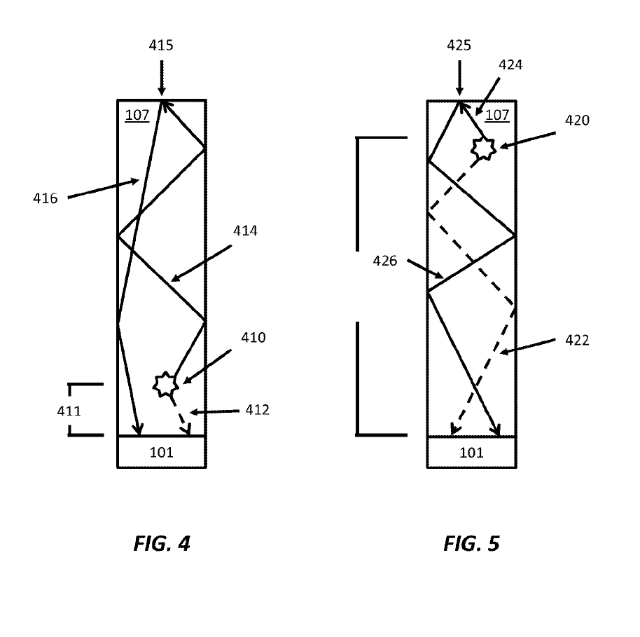

In a particular, non-limiting embodiment as described herein, the scintillator 107 has a depth of 7.5 cm. FIG. 4 illustrates a scintillation event 410 that occurs closer to the photosensor 101, and FIG. 5 illustrates a scintillation event 420 that occurs farther from the photosensor 101. Referring to FIG. 4, the scintillation event 410 has a DOI 411 of 1 cm. A first group of photons travels directly to the photosensor 101 without any reflections, and is represented by path 412 (dashed line). A second group of photons travels indirectly to the photosensor 101 through one or more reflections off the reflector 109 (illustrated in FIG. 1) that surrounds the scintillator 107, and is represented by paths 414 and 416 (solid lines), where light is returned toward the photosensor 101 at point 415. In this embodiment, the path 412 has a path length of 1.1 cm, the paths 414 and 416 have a combined path length of over 15 cm. A photon that is reflected by paths 414 and 416 will travel over 15 cm before such photon is received by the photosensor 101. Thus, the relative difference in lengths of paths before reaching the photosensor 101 is substantial, as the distance corresponding to paths 414 and 416 is over 13 times longer than along the distance corresponding to path 412.

Referring to FIG. 5, the scintillation event 420 has a DOI 421 of 6 cm. A first group of photons travels to the photosensor 101 and is represented by path 422 (dashed lines). A second group of photons travels to the photosensor 101 is represented by paths 424 and 426 (solid lines), where light is returned toward the photosensor 101 at point 425. In this embodiment, the path 420 has a path length of that is much closer to the combined path lengths for path 424 the path 426. Referring to FIG. 5, the path length corresponding to paths 424 and 426 may be no more than 2 times longer than the path length corresponding to path 422.

Since all photons emitted within the scintillator 107 travel at the substantially same speed through the scintillator 107 regardless of initial direction, the embodiment of FIG. 4 results in a larger time difference between the photons traveling to the photosensor 101 along path 412 and along paths 414 and 416, as compared to the time difference between the photons traveling to the photosensor 101, such as along path 422 and along paths 424 and 426 in the embodiment of FIG. 5. FIG. 6 includes a graph illustrating intensity of a pulse as a function of time for pulses at different DOIs. As seen in FIG. 6, a pulse corresponding to a scintillation event that occurs closest to the photosensor 101, which corresponds to the smallest DOI, has the longest rise time. A pulse corresponding to a scintillation event that occurs farthest from the photosensor 101, which corresponds to the largest DOI, has the smallest rise time. A pulse corresponding to a scintillation event that occurs between the other two scintillation events has an intermediate rise time. Thus, the rise time of a pulse corresponding to the scintillation event 410 in FIG. 4 will be longer than the rise time of a pulse corresponding to the scintillation event 420 in FIG. 5. Thus, a slower rise time correlates with a smaller DOI, and a faster rise time correlates with a larger DOI.

The rise time of a pulse can be determined in different ways. The rise time of the pulse is determined from a section spanning from a baseline of the pulse to the peak of the pulse. The baseline may be a predetermined intensity at which lower intensity is considered to be noise. In an embodiment, the rise time is the time difference between the times when the intensity of the pulse reaches 10% of the maximum intensity and when the intensity of the pulse reaches 90% of the maximum intensity. In another embodiment, the rise time is determined using times at 20% of the maximum intensity and 80% of the maximum intensity. In another embodiment, the rise time is determined using the rise time constant in double- or multiple-exponential fittings of the pulses.

As light travels though the scintillator 107 and is reflected on reflector 109, light is intensity is reduced through multiple reflections. As the DOI is larger (farther from the photosensor 101), the number of reflections which light encounter before reaching the photosensor 101 increases. Thus, as the DOI increases, both (1) the integration of intensity over time of a pulse and (2) the pulse height decrease, and integration of intensity over time of the pulse or the pulse height can be correlated to DOI. In an embodiment, the integration of intensity over time is determined by calculating the area under the intensity curve starting at a time when the intensity exceeds a baseline value until another time when the intensity no longer exceeds the baseline value. The pulse height is the maximum intensity of a pulse.

Data that includes previously collected or simulated data for DOI and its corresponding rise time, integration of intensity over time, and pulse height may have been previously obtained and stored in the look-up table 228 that can be part of the FPGA 226 or may be stored within another suitable electronic device. Information regarding rise time, integration of intensity over time, pulse height, or any combination thereof for a particular scintillation event can be compared to the data in the look-up table 228. The look-up table 228 may have the DOI information for the particular scintillation event without any further calculation. The look-up table 228 can provide a value for the DOI having a corresponding rise time, integration of intensity over time, pulse height, or any combination thereof that is closest to the rise time, integration of intensity over time, pulse height, or any combination thereof for the particular scintillation event. Alternatively, further calculations may be performed to provide a more precise value for the DOI for the particular scintillating event. For example, more than one value of DOI may be obtained from the look-up table 228 and a calculated DOI may be generated from such obtained DOI values. In another embodiment, another technique may be used to determine the DOI that corresponds to the particular scintillation event. Determination of DOI is optional and may be performed in particular embodiments in which such information is desired. In a particular embodiment, the DOI for the scintillation event can be used to image a radiation source that is being analyzed by the radiation detector apparatus.

The method can include generating a compensation coefficient, at block 324 in FIG. 3. The compensation coefficient can be based at least in part or completely on the rise time, integration of intensity over time, pulse height, DOI, or any combination thereof. The compensation coefficient can be generated and used to adjust a pulse parameter as will be discussed in more detail below. The compensation coefficient can be used to account for convolution within the pulse due to the reflections associated scintillating light within the scintillator 107.

Compensation coefficients and their corresponding rise times, integrations of intensity over time, pulse heights, and DOIs may have been previously obtained or simulated, and such data can be stored in the look-up table 228 that can be part of the FPGA 226 or may be stored within another suitable electronic device. Information regarding rise time, integration of intensity over time, pulse height, DOI, or any combination thereof for a particular scintillation event can be compared to the data in the look-up table 228. The look-up table 228 may have the compensation coefficient for the particular scintillation event without any further calculation, in which case, a value for the compensation coefficient having a corresponding rise time, integration of intensity over time, pulse height, DOI, or any combination thereof that is closest to the rise time, integration of intensity over time, pulse height, DOI, or any combination thereof for the particular scintillation event will be provided by the look-up table 228. Alternatively, further calculations may be performed to provide a more precise value for the compensation coefficient for the particular scintillating event. For example, more than one value of the compensation coefficient may be obtained from the look-up table 228 and a calculated compensation coefficient may be generated from such obtained compensation coefficient values. In another embodiment, another technique may be used to determine the compensation coefficient that corresponds to the particular scintillation event.

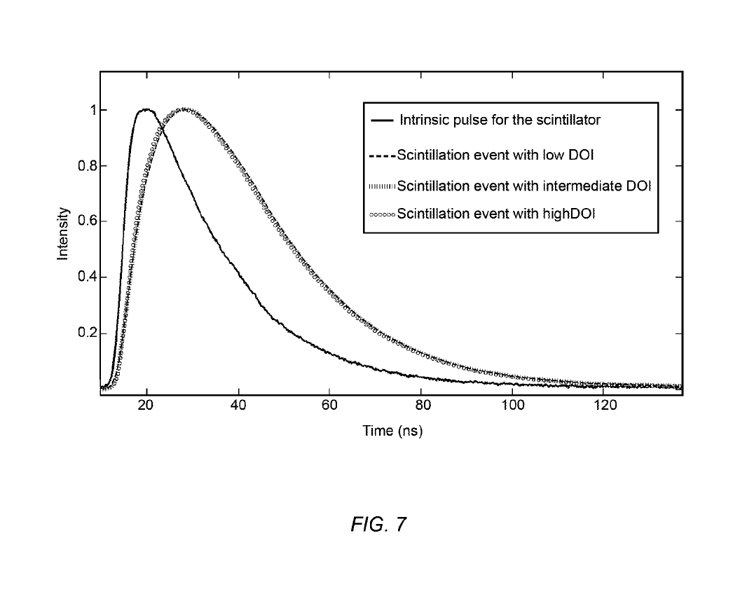

The method can further include adjusting a pulse parameter, at block 326 in FIG. 3. The compensation coefficient may be used to adjust the pulse height or another parameter of the pulse. In a particular embodiment, the pulse height can be adjusted such that the adjusted pulse represents a pulse where all photons emitted by a scintillation event within the scintillator 107 are received directly by the photosensor 101 without any reflections. Such a scintillation event is referred to herein as an intrinsic pulse. FIG. 7 includes a plot of the intrinsic pulse and pulses corresponding to scintillation events at different DOIs. By adjusting the pulse height by the compensation coefficient, the adjustment can reduce the variation in pulse height which is caused by the variation in DOI for pulses. Thus, energy resolution of the detector is improve. Energy resolution is typically measured as the full width at half maximum (FWHM) of a particular energy peak in the pulse height spectrum generated by the MCA 230. In another embodiment, the pulse parameter can include the rise time, the integration of intensity over time, another suitable pulse parameter, or any combination thereof. The adjusted pulse can then be sent to the MCA 230, to a pulse counter, to imaging equipment to image a radiation source, or another suitable use where the adjusted pulse will allow for faster or more accurate subsequent processing of the adjusted pulse corresponding to the scintillation event.

In an embodiment, any one or more operations in the method illustrated in FIG. 3 and described above can be performed at an operational frequency of at least 1 GHz. In particular, the digitization of the pulse, analysis of the pulse, generating a compensation coefficient, and adjusting the pulse parameter can be realized by using an FPGA, ASIC, or other device allowing for fast processing of data. The ability to perform the operations quickly can allow for more precise determination of the DOI, which in turn can allow for adjustment of a pulse parameter to allow a pulse for a particular scintillation event to be adjusted to allow for better post-adjustment analysis, such as pulse height analysis, pulse counting, radiation source imaging, or the like.

In another embodiment, a different scintillator-photosensor combination may be used. The scintillator may have a plate-like shape, and photosensors may be optically coupled to orthogonal sides of the scintillator. In this manner, the location of the scintillation event within the scintillator by using a DOI corresponding to an x-direction and another DOI corresponding to a y-direction. Thus, concepts as described herein can be extended to a scintillator in the shape of plate in place of pixels that may form an array or a sub-array of the radiation detection apparatus.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implement using digital circuits, and vice versa.

Item 1. An analyzer device including an input coupled to a photosensor that is optically coupled to a scintillator, wherein the scintillator has a first end and a second end opposite the first end, wherein the photosensor is coupled to the first end. The analyzer device includes a plurality of circuits, wherein the analyzer device is configured to receive a pulse from a photosensor at the input of the analyzer device, analyze a pulse shape of the pulse, and adjust a pulse parameter based on the analysis of the pulse shape, wherein the plurality of circuits is configured to perform the analysis of the pulse or the adjustment of the pulse.

Item 2. The analyzer device of Item 1, wherein the analyzer device is configured to analyze the pulse shape of the pulse includes the analyzer device is configured to determine a rise time of the pulse, wherein a faster rise time corresponds to a depth of interaction farther to the first end of the scintillator than the second end of the scintillator;

Item 3. An analyzer device is configured to receive a pulse from a photosensor optically coupled to a scintillator, wherein the scintillator has a first end and a second end opposite the first end, wherein the photosensor is coupled to the first end. The analyzer device is further configured to determine a rise time of the pulse, wherein a faster rise time corresponds to a depth of interaction farther to the first end of the scintillator than the second end of the scintillator; and adjust a pulse parameter based on the rise time.

Item 4. The analyzer device of Item 2 or 3, further configured to generate a compensation coefficient based on the depth-of-interaction, the integration of scintillation light intensity over time, the pulse height of the pulse, the rise time of the pulse, or a combination thereof.

Item 5. The analyzer device of any one of Items 1 to 4, further configured to digitize the pulse before the pulse shape is analyzed.

Item 6. The analyzer device of any one of the preceding Items further configured to perform digitization of the pulse, analysis of the pulse shape, or both at an operating frequency of at least approximately 1 GHz.

Item 7. The analyzer device of any one of the preceding Items, further including a plurality of circuits configured to perform the analysis of the pulse.

Item 8. The analyzer device of Item 7, wherein the plurality of circuits includes a field programmable gate array or an application specific integrated circuit, wherein analysis of the pulse shape, determination of the depth-of-interaction, determination of a pulse rise time, integration of intensity over time, or any combination thereof is performed by the field programmable gate array or the application specific integrated circuit.

Item 9. The analyzer device of any one of Items 2 to 8, wherein the analyzer device is configured to determine the rise time, wherein the faster rise time corresponds to the depth of interaction farther to the first end of the scintillator than the second end of the scintillator.

Item 10. The analyzer device of any one of Items 4 to 9 further configured to adjust the pulse parameter using the compensation coefficient.

Item 11. The analyzer device of any one of Items 1 to 10, wherein the pulse parameter is the pulse height.

Item 12. The analyzer device of any one of Items 1 to 10, wherein the pulse parameter is an integration of pulse intensity over time.

Item 13. The analyzer device of any one of Items 4 to 12, further configured to access a look-up table, wherein the look-up table is used to generate the compensation coefficient.

Item 14. A radiation detection apparatus including a scintillator, a photosensor, and the analyzer device of any one of Items 1 to 13.

Item 15. The analyzer device or the radiation detection apparatus of any one of Items 1 to 14, wherein a distance between the first end and the second end of the scintillator is at least 7.5 centimeters.

Item 16. The analyzer device or the radiation detection apparatus of any one of Items 1 to 15, wherein the scintillator has a rise time of no greater than 2 nanoseconds, a decay time of no greater than 20 nanoseconds, or both.

Item 17. The analyzer device or the radiation detection apparatus of any one of Items 1 to 16, wherein the scintillator includes a rare earth halide.

Item 18. The analyzer device or the radiation detection apparatus of Item 16, wherein the scintillator includes La₍₁₋ₓ₎CeₓBr₃, wherein x is any number in the range of 0 and 1, such as any number in the range of 1×10⁻³ to 0.4.

Item 19. The analyzer device or radiation detection apparatus of any one of the preceding Items, wherein the photosensor includes a photomultiplier tube, a photodiode, a hybrid photosensor, or any combination thereof.

Item 20. A method of using an analyzer device including providing the analyzer device electrically coupled to a photosensor optically coupled to a scintillator, generating a pulse in response to receiving scintillation light, receiving the pulse from the photosensor, analyzing a pulse shape of the pulse, and adjusting a pulse parameter based on the pulse shape.

Item 21. The method of Item 20, further including generating and using the compensation coefficient to adjust the pulse parameter.

Item 22. The method of Items 20 or 21, further including digitizing the pulse before the pulse shape is analyzed.

Item 23. The method of Item 22, wherein digitizing the pulse, analyzing the pulse shape, or both is performed at an operating frequency of at least approximately 1 GHz.

Item 24. The method of any one of Items 20 to 23, wherein analyzing the pulse shape, determining the depth-of-interaction, determining the pulse rise time, integrating intensity over time, or any combination thereof is performed by a field programmable gate array or an application specific integrated circuit.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An analyzer device comprising:
an input coupled to a photosensor that is optically coupled to a scintillator, wherein the scintillator has a first end and a second end opposite the first end, wherein the photosensor is coupled to the first end,
wherein the analyzer device comprises a plurality of circuits, wherein the analyzer device is configured to:
receive a pulse from a photosensor at the input of the analyzer device;
analyze a pulse shape of the pulse; and
adjust a pulse parameter based on the analysis of the pulse shape, wherein the plurality of circuits is configured to perform the analysis of the pulse or the adjustment of the pulse.

2. The analyzer device of claim 1, wherein the analyzer device is configured to analyze the pulse shape of the pulse comprises the analyzer device is configured to determine a rise time of the pulse, wherein a faster rise time corresponds to a depth of interaction farther to the first end of the scintillator than the second end of the scintillator;

3. An analyzer device configured to:
receive a pulse from a photosensor optically coupled to a scintillator, wherein the scintillator has a first end and a second end opposite the first end, wherein the photosensor is coupled to the first end;
determine a rise time of the pulse, wherein a faster rise time corresponds to a depth of interaction farther to the first end of the scintillator than the second end of the scintillator; and
adjust a pulse parameter based on the rise time.

4. The analyzer device of claim 2, further configured to perform digitization of the pulse, analysis of the pulse shape, or both at an operating frequency of at least approximately 1 GHz.

5. The analyzer device of claim 2, wherein the analyzer device is configured to determine the rise time, wherein the faster rise time corresponds to the depth of interaction farther to the first end of the scintillator than the second end of the scintillator.

6. The analyzer device of claim 2, further configured to generate a compensation coefficient based on the depth-of-interaction, the integration of scintillation light intensity over time, the pulse height of the pulse, the rise time of the pulse, or a combination thereof.

7. The analyzer device of claim 6, further configured to adjust the pulse parameter using the compensation coefficient.

8. The analyzer device of claim 6, further configured to access a look-up table, wherein the look-up table is used to generate the compensation coefficient.

9. The analyzer device of claim 1, wherein the pulse parameter is the pulse height.

10. The analyzer device of claim 1, wherein the pulse parameter is an integration of pulse intensity over time.

11. A radiation detection apparatus comprising:
a scintillator;
a photosensor; and
the analyzer device of claim 1.

12. The analyzer device of claim 1, wherein a distance between the first end and the second end of the scintillator is at least 7.5 centimeters.

13. The analyzer device of claim 1, wherein the scintillator comprises a rare earth halide.

14. The analyzer device of claim 1, wherein the scintillator has a rise time of no greater than 2 nanoseconds, a decay time of no greater than 20 nanoseconds, or both.

15. The analyzer device of claim 14, wherein the scintillator comprises La₍₁₋ₓ₎CeₓBr₃, wherein x is any number in the range of 0 and 1, such as any number in the range of 1×10⁻³ to 0.4.

16. A method of using an analyzer device comprising:
providing the analyzer device electrically coupled to a photosensor optically coupled to a scintillator;
generating a pulse in response to receiving scintillation light;
receiving the pulse from the photosensor;
analyzing a pulse shape of the pulse; and
adjusting a pulse parameter based on the pulse shape.

17. The method of claim 16, further comprising generating and using the compensation coefficient to adjust the pulse parameter.

18. The method of claim 16, further comprising digitizing the pulse before the pulse shape is analyzed.

19. The method of claim 18, wherein digitizing the pulse, analyzing the pulse shape, or both is performed at an operating frequency of at least approximately 1 GHz.

20. The method of claim 16, wherein analyzing the pulse shape, determining the depth-of-interaction, determining the pulse rise time, integrating intensity over time, or any combination thereof is performed by a field programmable gate array or an application specific integrated circuit.
